(19) United States
(12) Patent Application Publication
(10) Pub. No.: US 2008/0165354 A1
(43) Pub. Date: Jul. 10, 2008

(54) Method and Apparatus For Dissolving Solid Matter in Liquid

(75) Inventors: Jukka Rantanen, Copenhagen (DK); Jaakko Aaltonen, Espoo (FI); Jouni Hirvonen, Vantaa (FI); Leena Peltonen, Klaukkala (FI)

Correspondence Address: MCCORMICK, PAULDING & HUBER LLP, CITY PLACE II, 185 ASYLUM STREET, HARTFORD, CT, 06103, US

(73) Assignee: HELSINGIN YLIOPISTO, Helsingin Yliopisto (FI)

(21) Appl. No.: 11/911,436

(22) PCT Filed: Apr. 10, 2006
(86) PCT No.: PCT/FI06/00111

§ 371 Date: Jan. 3, 2008

(30) Foreign Application Priority Data
Apr. 14, 2005 (FI) 20050385

(51) Int. Cl. G01J 3/44

(52) U.S. Cl. 356/301

(57) ABSTRACT

The invention concerns a method and apparatus for monitoring physical and chemical properties of a solid sample during a dissolution process, the sample comprising at least one soluble component. In the method, the solid sample is brought into contact with dissolution medium for producing a solution and a solid residue of the solid sample, the solution is analyzed for determining the concentration of the soluble component during the dissolution process. Simultaneously with analyzing the solution, the atom- or molecule-scale physical or chemical composition of the solid residue is analyzed. The invention provides a new method for studying phenomena taking place in the solid residue during a dissolution process.

### BACKGROUND OF THE INVENTION

1. Field of the Invention

The present invention relates to dissolution of matter. In particular, the present invention concerns a method for monitoring physical and chemical properties of a solid sample during a dissolution process. The invention also concerns an apparatus related to such a method.

2. Description of Related Art

Dissolution tests are widely utilized in developing, manufacturing and analyzing pharmaceutical products, especially in quality control applications. In a dissolution test, a drug substance or drug formulation is immersed into a medium and the concentration of the drug substance in the medium is measured over time. The obtained release profile of the drug substance is usually compared to previously measured profiles to be able to detect possible variations in the release behaviour. In quality control applications, a dissolution test can, for example, serve as a tool for obtaining information on the test batches and reference products used in bioavailability/bioequivalency studies and pivotal clinical studies and as a tool for quality control after the manufacturing phase of drugs. In studying the bioequivalence of drugs, dissolution tests can be used for demonstrating similarity (or dissimilarity) of products and different formulations of active pharmaceutical ingredients.

Pharmaceutical legislation is very detailed. The most important objective behind the detailed legislation is to ensure continued protection of public health. It has been estimated that the cost for developing a new drug is over US$800 million. Marketing and competitive pressures call for streamlined development and reduced costs. At the same time there is a great need to bring the drug to market as soon as possible. Solubility testing is critically important throughout pharmaceutical research. At the later stages of the drug development, the solubility and dissolution of the drug become practically inseparable entities. Thus, the dissolution test has become a standard test for evaluating pharmaceutical solid dosage forms.

Many different types of equipment have been developed for measuring dissolution rates of pharmaceutical dosage forms, some of which have also been accepted for publication in the official Pharmacopoeias (e.g. European Pharmacopoeia, United States Pharmacopeia, Japanese Pharmacopoeia).

U.S. Pharmacopeia (USP) has approved seven different dissolution apparatuses (USP I-USP VII), which are described, for example, in the publication USP 27, sections <711> and <724>.

The basic operational principle of dissolution devices is to contact dissolution medium with a dosage form and to mix the dissolution medium for getting a homogeneous solution. A device can comprise a vessel, which is filled with a solvent, i.e., the dissolution medium, the dimensions of the vessel and the pH, temperature and composition of the solvent being strictly regulated by the authorities. The release profile of the active agent of the dosage form is then measured from the solution. Small amounts of the solvent are frequently conducted from the vessel into analysis equipment for analysis of the concentration of the drug substance in the dissolution medium. A High Performance Liquid Chromatography (HPLC) method or a UV-spectroscopic analysis method is commonly employed in the concentration analysis.

Recently, a biopharmaceutics classification system (BCS) has been introduced for classification of drugs based on their solubility in aqueous media and intestinal permeability (Amidon et al., Pharm. Res. 12: 413). Later it has been adopted by regulatory agencies. It has been recognized that dissolution rate has a negligible impact on bioavailability of highly soluble and highly permeable (BCS Class I) drugs when the dissolution rate of the formulation is sufficiently high. As a result, various regulatory agencies, including the United States Food and Drug Administration (FDA), now allow bioequivalence of formulations of BCS Class I drugs to be demonstrated by in vitro dissolution (often called a biowaiver). Using the above criteria, approximately 25% of all compounds were classified as highly soluble and permeable (BCS Class I). This fact emphasizes the continuously increasing importance of dissolution testing. During the past few years, the dissolution testing has become even more important in view of the increasing market share of generic drugs. A generic drug is identical, or bioequivalent, to a brand name drug in dosage form, safety, strength, route of administration, quality, performance characteristics and intended use. Although generic drugs are chemically identical to their branded counterparts, they are typically sold at significantly lower prices than the branded product. To gain approval by, for example, FDA, a generic drug must be bioequivalent, which can be verified using dissolution tests.

During the past decades, there have been very few changes to the test protocols. The most important modernizations of the dissolution technology have been the introduction of robotic elements in sample taking, new computer software elements for the calculation of test results, and the in situ sample analysis method, which is disclosed in U.S. Pat. Nos. 6,174,497 and 6,580,506. As regards the latter it can be noted that traditional dissolution testing involves transfer of samples outside the dissolution vessels for measurement and data generation. In the in situ dissolution method, the samples are not transferred from the test vessel, but the dissolution medium is analysed in the test vessel with the aid of optical fibers.

Globally the most important manufacturers for dissolution test equipment are Sotax AG, Erweka GmbH, Varian Inc, Distek Inc, Hanson Research Rose Scientific Ltd, Electrolab, G. B. Caleva Ltd, Pharma-Test AG and Logan Instruments Co. Some examples of modem solution analysis devices include UV-based low-volume minimal-hydrodynamic-effect fiber optic probes (ARCH™, U.S. Pat. No. 6,580,506) by Leap Technologies, Inc., and UV dip probes within the hollow shaft of a USP paddle stirrer (U.S. Pat. No. 6,174,497) by Delphian Technology Inc.

U.S. Pat. No. 6,799,123 discloses a method and equipment of dissolution testing that encompasses two or more chambers. The first chamber is capable of transferring solid particles to the second chamber. The second chamber is capable of retaining solid(s). The chambers have means for adding test materials. The chambers have means for mixing the sample and medium; and means for analyzing the effluent. Analysis can be carried out several times during the operation of the test equipment.

U.S. Pat. No. 6,762,841 describes a method of performing spectral analysis in a pharmaceutical dissolution process. The method comprises inserting a fiber optic probe of a spectral analyzer into a dissolution vessel. The dissolution vessel contains a dissolution medium. The method further comprises transmitting light along the optic pathway, and analyzing the transmitted light for determining certain optical properties of the dissolution medium in the optic pathway.

U.S. Pat. No. 6,750,966 discloses a method for on-line monitoring of the dissolution of small particles by using light scattering. The method comprises the steps of combining the solid material and the liquid medium, determining the initial solids concentration, determining the dynamic solids concentration using a light scattering technique, and calculating the percent of dissolved material.

In U.S. Pat. No. 6,162,465 there is described a method for analyzing the dissolution behaviour of a plurality of dosage units simultaneously. Monitoring can be made using known techniques either destructively or non-destructively. The method may be utilized as a feed-back data collection method when manufacturing of drug formulations.

In the publication WO 03/034060, a method is disclosed for monitoring the outward appearance of a tablet during the dissolution process using video technique. The equipment described in the publication includes a video equipment, which provides a series of images of the tablet or other dosage form as the dissolution proceeds. The method is suited for analyzing macroscopic mechanical changes, such as tears, ruptures and pieces of breaking off, in the dosage form during the process. U.S. Pat. No. 4,855,821 discloses another video monitoring device for dissolution and disintegration experiments.

Another apparatus for monitoring the disintegration of a drug is disclosed in U.S. Pat. No. 5,827,984. The apparatus includes means for measuring macroscopic properties, such as thickness, width or volume of a dosage form immersed in liquid.

WO 97/46860 discloses a method for continuously measuring the amount of active agent of the drug released by means of UV-, IR, near-IR, fluorescence, electrochemical, Nuclear Magnetic Resonance (NMR) or Raman spectroscopy techniques. A probe is mounted inside the mixing shaft. From the data gained, predictions on the actual dissolution curve can be made. Thus, the publication provides an indirect method for measuring the dissolution curve.

The rate of drug release from a drug formulation is related to both the properties of the drug substance and the composition of drug formulation. Solid state properties, for example, the amorphosity vs. crystallinity of the material, play a crucial role in the dissolution behaviour of a solid system. Also the dissolution media may have an impact on the behaviour of the solid material, and these changes may alter the dissolution behaviour of the drug formulation / drug substance. Interactions with the dissolution medium may also result in dissolution of material and after that, in re-crystallization of new solid matter. The newly solidified matter can take a new polymorphic form, which is sometimes difficult to predict, because these changes are constituted by alterations in the packing behaviour at atomic or molecular level. It can also occur that an initially amorphous component of the drug sample is dissolved and re-solidified on the sample in crystalline form. Crystalline forms of matter are often more stable than their amorphous counterparts, whereby the dissolution rate can be decreased. Another typical example of possible changes in the sample is the formation of hydrates or solvates. In addition, the components of the drug can form salts and/or different salt forms, their isomeric properties (e.g., chirality) may be affected, oxidation or reduction reactions and different water-solid interactions can take place, and there may also be formed chelate compounds.

These abovementioned atom- and molecule-scale changes in the chemistry and/or physical state of the sample affect the further disintegration and dissolution properties of the drug, probably affecting also the bioequivalency of the drug. In particular, the formation of new polymorphs and/or hydrate or solvate compounds of the active pharmaceutical ingredient or other compound in formulation can have a lower/higher solubility or decreased/increased dissolution rate, or the polymorphic changes and/or forming of hydrate or solvate compounds of other ingredients can form an indirect “dissolution barrier”.

It has been found that even drugs, which have been fabricated in the same production line and even in the same production run, can have very dissimilar dissolution properties. The reason for this behaviour is in the initial composition of the dosage form. There may be undesired and unpredictable defects in the drug which initiate formation of, for example, dissolution barriers. Such an undesired defect can be formed, for example, of only one hydrate crystal, which acts as a nucleate for further hydration processes taking place in the sample. The impact of such dissolution barrier on the measured dissolution time can be tens of percents, for example, several hours. Thus, also the biological effect of defected drugs is delayed significantly. Detection of the formation of polymorphs or compounds with lower/higher solubility or decreased/increased dissolution rate, or dissolution barriers during dissolution, has so far not been possible. However, identifying such changes and other defects in drugs would offer new possibilities of developing new pharmaceuticals and making the production processes more efficient and increase the level of safety in health care system. Variations in the composition of the drugs have also an effect on the stability and shelf-life of the drugs.

In Pharmaceutical Research, Vol 21, No. 1, Jan. 2004, pp. 149-159: “Use of Glancing Angle X-Ray Powder Diffractometry to Depth-Profile Phase Transformations During Dissolution of Indomethacin and Theophylline Tablets”, Debanath et al. have studied the crystallinity of tablets after being exposed to dissolution medium for given periods. In the article, the diffractometric results obtained after the exposure periods are combined with intrinsic dissolution curves of the tablets. The dissolution process is interrupted in order to carry out the analyses.

In Journal of Pharmaceutical and Biomedical Analysis, Vol 35 (2004), pp. 715-726, Romero et al. present another off-line method for measuring dissolution profiles and crystalline modifications of drugs. At some stage of the solubility measurements, the measurements were interrupted and the solids of the drug were filtrated and analyzed by differential scanning calorimetry, hot stage microscopy, KBr IR spectrometry, X-ray powder diffraction and Karl-Fischer method.

In Ind. Eng. Chem. Res., Vol 44, 2005, pp. 1233-1240: “Crystallization Monitoring by Raman Spectroscopy: Simultaneous Measurement of Desupersaturation Profile and Polymorphic Form in Flufenamic Acid Systems”, Hu et al. have studied the crystallization processes of flufenamic acid (FFA) in ethanol, toluene and water mixtures. In the crystallization experiment disclosed in the article, a Raman probe was immersed in the mixture and a sum signal from both the liquid and the formed crystals was collected for further analysis.

In the research and development phase of drugs, dissolution tests are everyday practice. As regards to some pharmaceuticals, in the fabrication phase even tens of percents of production runs are discarded or reprocessed due to failings in quality control tests. Although research and development takes a lion's share of drug costs, the trend nowadays is towards also more efficient production lines. Thus, more extensive dissolution methods are required throughout the product life cycle.

Known dissolution methods provide numerous methods for measuring the dissolution curve and some techniques for observing the visual or dimensional state of the drug formulation. There are, however, no methods which could be used for finding out the atom- and molecule-scale reasons explaining the observed behaviour of the dissolution curve.

### SUMMARY OF THE INVENTION

It is an aim of the present invention to eliminate at least some of the problems of the prior art and to provide a novel dissolution method for obtaining information on the physical and chemical changes of drugs due to interactions with dissolution medium and/or mutual interactions of the components of the drug during dissolution.

It is another aim of the invention to provide a novel apparatus suitable for the present dissolution method, providing means for accessing the physical and chemical phenomena taking part in the tablet or other dosage form during dissolution.

It is another aim of the invention to provide a method and apparatus for detecting such defects and individual differences of dosage forms that affect the dissolution behaviour of the drug.

The invention is based on the idea of measuring the properties of the solid state components of the pharmaceutical simultaneously with analyzing its dissolved components.

In the method according to the invention, a solid sample comprising at least one soluble component is brought into contact with a dissolution medium for producing a solution and a solid residue (i.e., a remaining solid portion) of the sample, and the solution is analyzed for determining the concentration of the soluble component simultaneously with analyzing the composition of the solid residue during the dissolution process.

The method can be carried out in an apparatus which comprises a cavity or in the vessel into which dissolution medium can be fed and means for contacting the sample in the cavity or in the vessel with the dissolution medium for producing a solution and a solid residue of the sample. The apparatus further comprises the combination of analyzing means of two different kinds, namely a first set of means for analyzing the solution for determining the concentration of the soluble component, and a second set of means for analyzing the composition of the solid residue.

More specifically, the method according to the invention is characterized by what is stated in the characterizing part of claim 1.

The apparatus is mainly characterized by what is stated in the characterizing part of claim 17.

Considerable advantages are obtained by means of the invention. Thus, during and after the experiment, both the data on the time course of the concentration of the active agent of the drug (dissolution curve) and data on the time course of the content of desired solid component or components of the undissolved drug product are available. In the presently approved dissolution tests, if the dissolution curve is not as expected or desired, there have been no means for accessing the reasons for such behaviour. That is, after the tablet has dissolved, it no longer exists. Therefore, all required data has to be collected during a single experiment. In former dissolution test apparatuses, simultaneous detection of both the concentration of the dissolved material in the media and the physical or chemical properties of the yet undissolved or re-solidified material have not been possible. In brief, prior techniques necessitating interruption of the experiment in order to analyze the solids, can not be used to explain the temporal behaviour of the dissolution profile accurately. On the other hand, in methods necessitating several measurement runs, information on the individual properties of the sample is lost.

By combining the acquired data on the solid state of the drug with the data on the dissolved matter, reasonable hypotheses on the reactions taking part on or in the tablet can be made. For example, if the dissolution slows down at some point of the experiment and the hydrate content of the solid phase increases simultaneously, it can be anticipated that the hydrate formed into the tablet inhibits the dissolution. By means of the present invention, these kinds of causal connections are seen readily during the experiment, i.e., when the phenomena occur. That is, from the simultaneous material analysis also reasons for problems in the solubility/dissolution testing due to the changes in the physical state of the matter are detectable at the very moment when the problems first time may be seen from the dissolution/solubility data. In traditional dissolution testing protocols, the seeking of the possible reasons for the deviations in the dissolution results has started not before the dissolution tests have already been done. At this stage the sample has already dissolved but not a single analysis can be run to solve the problem. Thus, the method provides also for time-savings, and further great economical savings, especially in the research and development phase of new drugs. Savings of money and time in drug development allows new medicines to enter the markets faster. When the product development cycle in the drug industry is shortened, the savings in the money (=total costs to get a new entering medicine into the market) may be seen also in the prices of the medicines.

In addition to product development, also the reliability and effectiveness of product quality control can be improved. Dissolution testing is now a standard method in the quality control of drug substances and also a control test for scale-up or post approval changes (SUPAC). When also the accurate information from the properties of the solid substance is added to the dissolution information, quality of products can be increased and also the possible problems related to dissolution can be identified, specified and solved at an early stage, resulting in further savings in money and time. Savings are also achieved due to decreased number of rejected and abandoned production runs.

In drug industry the new technique will introduce great benefits at least both in the area of drug development as well as in quality control. Another aspect is the growing generics market, which underline the importance of product similarity testing and by this means, the importance of dissolution testing.

The invention also provides a method for detecting potential dissolution-affecting defects, such as crystal defects, present in the drug product. The defects can be either in the structure (physical state) or elements (chemistry) of the sample, for example, undesired polymorphs, compounds, contaminants or by-products of the production processes or disadvantageous amounts of ingredients. The defects are detected indirectly by comparing the measured data on the solid residue and on the dissolution medium with experimental and computational data on dissolution of defected and non-defected samples. However, in most cases the defects can be detected and even identified at an early phase of the test, since indications of exceptional dissolution behaviour can usually be seen already in the beginning of the dissolution process.

As appreciated by a person skilled in the art, besides the pharmaceutical industry and research also other sectors of industry (e.g. food, fertilizers, and detergents) will benefit from the new technique. Also in these areas, the dissolution of solid material is one of the key issues of product performance and the solid state properties are expected to affect it.

Next, the invention will be examined more closely with the aid of a detailed description and with reference to the attached drawings.

### BRIEF DESCRIPTION OF THE DRAWINGS

FIG. 1 shows a schematic representation of an apparatus according to the invention,

FIG. 2 shows a block diagram of the method according to the invention,

FIGS. 3a to 3c show three orthogonal cross-sections of a flow-through dissolution chamber exhibiting a window for analysis of the solid residue,

FIG. 4 shows a schematic cross-section of a dissolution apparatus comprising a probe for analysis of the solid residue,

FIG. 5 shows a schematic cross-section of an alternative apparatus comprising a probe for analysis of the solid residue,

FIG. 6 shows a cross-sectional view of a detailed embodiment of a Ph. Eur.-type dissolution paddle apparatus supplemented with a probe for analysis of the solid residue,

FIGS. 7a and 7b show cross-sectional views of a detailed embodiment of a Ph. Eur.-type dissolution basket apparatus supplemented with a probe for analysis of the solid residue,

FIG. 8 shows microscopic images of sulfaguanidine slurry before and after immersion in water,

FIG. 9 shows the state of the liquid phase and the solid phase as a function of time for a tablet formulation comprising theophylline monohydrate as a soluble component,

FIG. 10 shows the state of the liquid phase and the solid phase as a function of time for a tablet formulation comprising theophylline anhydrate as a soluble component,

FIG. 11 shows the state of the liquid phase and the solid phase as a function of time for a tablet formulation comprising 1:1 (weight) microcrystalline cellulose: theophylline anhydrate,

FIG. 12a shows the solid phase transformation of NF anhydrate to NF monohydrate (II) as a function of time, and

FIGS. 12b and 12c show the concentration of the dissolution medium in two different time scales in the experiment relating to FIG. 12a.

### DETAILED DESCRIPTION OF THE INVENTION

The dissolution method disclosed in this document can in principle be applied to all conventional dissolution methods and apparatuses.

According to the present method, the solid sample and the dissolution medium are contacted for dissolving the soluble components of the sample into the dissolution medium. There is thus formed a solution and a remaining solid residue of the sample, which can also be referred to “the liquid phase” and “the solid phase” of the system, respectively. The liquid phase and the solid phase are analyzed simultaneously. The term “solid residue” refers also to such dissolved matter which re-solidified on the sample, potentially in different chemical or physical form. The sample can be in any solid dosage form, including, for example, tablets, capsules and powders. In addition to dosage forms comprising essentially only solids, also semi-solid products, such as gels, can be subjected to the present method. The sample can be composed of essentially 100% active pharmaceutical ingredient (API) or it can be a product having several excipients in addition to the API. The solid residue analysis according to the method can be focused on the API or any other ingredient of the product. There can also be several substances of interest.

Referring to FIG. 2, the dissolution method used is denoted with a reference number 20. The present method is applicable to a variety of dissolution methods 20. The sample can be immersed in a dissolution medium placed in a suitable vessel, for example, according to the operational principle of USP I-III and V-VII apparatuses. Alternatively, the sample can be mounted in a flow-through cell, for example, as in the apparatus USP IV. In addition to dissolving methods based on immersing or flow-through arrangements, the present analysis method can be applied to all methods, in which a solid sample is contacted with a solvent for dissolving at least part of the sample. The sample is preferably mounted in an essentially fixed location relative to surroundings and/or at least part of the solid state analysis means discussed below.

In the present method a combination of analyzing means of two different kinds are utilized. A first set of means is used for analyzing the solution for determining the concentration of the soluble component, and a second set of means is used for analyzing the composition of the solid residue. The first and second sets of means are chosen to yield the desired information on the solution and on the solid residue, respectively.

Analysis of the solution 22 can be carried out by any method that provides the desired information on the solution, for example, the concentration of the active agent of the sample. These methods include, for example, chromatographic separation methods, such as High Performance Liquid Chromatography (HPLC) and UV-spectrometric methods, i.e., methods in which the relative amounts of either absorbed or transmitted/reflected radiant energy or radiant flux as a function of wavelength are measured. Also volumetric analysis and electrochemical analysis techniques can be used. Examples of possible HPLC-techniques include ion-exchange and size exclusion HPLC. Typical spectrometric methods include, for example, methods based on UV or UV to visible (UV-vis) radiation. Other possible methods of liquid phase analysis are methods based on fluorescence, or electrochemical reactions or methods based on detecting vibrational states of the molecules, such as Raman spectroscopy. The analysis of the liquid phase can be made by sampling but it is preferably made in situ without removing liquid from the system or additional circulation of liquid from the dissolution vessel to analysis means. This can be achieved by using, for example, optical methods with the aid of optical fibers and/or, in the case of flow-through apparatuses, by utilizing the existing liquid circulation of the system.

Analysis of the solid residue 24 can be carried out by any method that provides information on the composition of the sample. A suitable solid phase analysis means, i.e., means for analyzing the solid residue, can be employed for that purpose. Exemplary solid state analysis methods are described below. By the term “composition” we refer to atom- or molecule-scale physical and chemical composition and structure. Examples of quantities and phenomena which can be detected using the solid phase analysis means are contents of different components of the residue, hydration and solvation reactions of the active agent or excipients in the residue, the crystal (or amorphous) state of the residue, re-crystallization of the dissolved components on the residue and changes in the polymorphous composition and chemistry of the residue. Also the wettability and disintegration properties of the sample can be monitored. All the mentioned phenomena can have a noticeable effect on the dissolution rate of the sample, whereby their direct monitoring provides important information on the dissolution behaviour. In particular, detecting these phenomena simultaneously with traditional dissolution measurements contributes to understanding the problems related to dissolution and developing of new pharmaceutical compositions having more beneficial pharmaceutical effects. Depending on the method used, the analysis can be focused on a distinct spot on the sample, on the whole surface of the sample or in its whole volume. The analysis can also aim at studying solid state phenomena during dissolution using depth profiling.

Dissolution tests can last from seconds to several days, sometimes even years, depending on the solubility of the sample and the measurement set-up. According to the present method, the liquid and solid phases of the dissolution system are analyzed simultaneously. Simultaneous analysis refers to such analysis, wherein during the test data, i.e. measurement results, are acquired both from the liquid phase and the solid phase at least once during the test period. Both the acquisitions can be performed without having to interrupt or interfere the other. In typical tests, however, data is acquired from both of the tests over the entire duration of the experiment. The analyses of both the solute and the residue can be either continuous or sequential. Thus, data is preferably acquired at several time points during the experiment, but the number of data acquisition points and acquisition intervals can be different for the two branches 22, 24 of analysis.

According to one embodiment, the data acquired from both the solid phase and liquid phase are transferred to data acquisition means 26, which can comprise one or more data acquisition and/or data processing and/or display units.

The analysis of the solid residue 24 can be carried out, for example, by spectroscopic or diffractometric means. Applicable spectroscopic methods include, e.g., UV, IR (including Near-, and Far-IR) and Raman spectroscopies. X-ray spectroscopy, diffractometry or crystallography can also be employed. In this document the term “X-ray spectroscopy” covers all analytically applicable usage forms of X-rays. In addition, methods based on induced fluorescence can be utilized in the solid state analysis. In principle, also Magnetic Resonance Spectroscopy (MRS), i.e., spectroscopic analysis based on Nuclear Magnetic Resonance (NMR) phenomenon, can be employed. Analysis based on MRS requires, however, considerable changes in the existing dissolution equipment, as the dissolution vessel or cell and required analysis devices have to be adapted for compliance with magnetic measurement environment. Also terahertz spectroscopy and second harmonic generation methods are can be used for the solid phase analysis.

According to one embodiment, methods utilizing radiation, such as IR and Raman spectroscopy, are used. In this case, the analysis can be carried out by using a fiber optic probe, which is placed in the vicinity of the solid sample and connected to an external spectroscopic unit. For example, when applied on the presently approved methods USP I-III or V-VII, the probe can be placed inside the rotating or reciprocating shaft or paddle (or equivalent) of the apparatus such that one end of the probe extends in the vicinity of the dosage form. Alternatively, the probe can be placed outside the dissolution vessel or led into the vessel through an opening in the wall of the vessel such that one end of the probe comes near the sample. By the terms “near the sample” or “in the vicinity” of the sample we refer to such position, which enables spectroscopic analysis of the solid sample without interfering contribution from the potential liquid phase between the sample and the solid phase. When the probe is placed outside the dissolution vessel, the vessel is preferably either made of, or exhibits a window that is permeable to the wavelength used. For preventing undesired drift in the measurement, the probe can also be adapted to move such that the distance between the surface of the sample and the probe head stays essentially constant as the sample dissolves. Alternatively, the probe can be arranged in a position, where no liquid is let between the probe and the sample. In this case, the measurement can be, for example, a depth-profiling measurement. When applied on the USP IV apparatus or other flow-through apparatus, the probe can be lead through the wall of the chamber, where the sample is mounted, into suitable position for the analysis. Alternatively, the flow-through chamber can exhibit a window and a probe is placed outside the window.

According to one embodiment, X-rays are used for the analysis of the residue. These methods are especially beneficial, when the ratio of the amount of crystalline components compared to the amount of amorphous components of the sample is high. A typical method is X-ray powder diffraction (spectroscopy), wherein the randomly oriented crystal structures of the sample are subjected to X-ray radiation and the distribution of the diffraction angles of the rays is measured. From the measured data, the crystal structure of the crystalline components can be calculated. Although being called “powder diffraction”, the sample does not have to be literally in powder form. Powder diffraction data can be collected either by detecting the radiation reflected from the sample or the radiation transmitted through the sample. In this embodiment, the dissolution vessel or chamber is provided with at least one X-ray permeable window and the sample, e.g., a tablet, is placed in the vicinity of the window. Two windows can be placed such, that the incident and reflected or transmitted X-rays are lead through different windows.

According to an advantageous embodiment, the sample is placed in a flow-through chamber, which is arranged in an X-ray diffractographic device. By this means, one can measure the release rate of the active agent from the liquid phase, crystal properties of the sample effectively by the X-rays, and, for example, the Raman spectra of the sample simultaneously. The flow-through chamber can exhibit separate windows for the fiber optic probe and for the X-rays, or the measurements can be carried out through one window with suitable placed probes.

According to one embodiment, thermal methods can be applied in analyzing the solid residue. Thermal methods include, for example, calorimetric or IR measurements of the heat content of the system. From the possible temperature changes, conclusions on the types of reactions taking place in the residue can be made (i.e., the amount or the ratio of endo- and exothermic reactions).

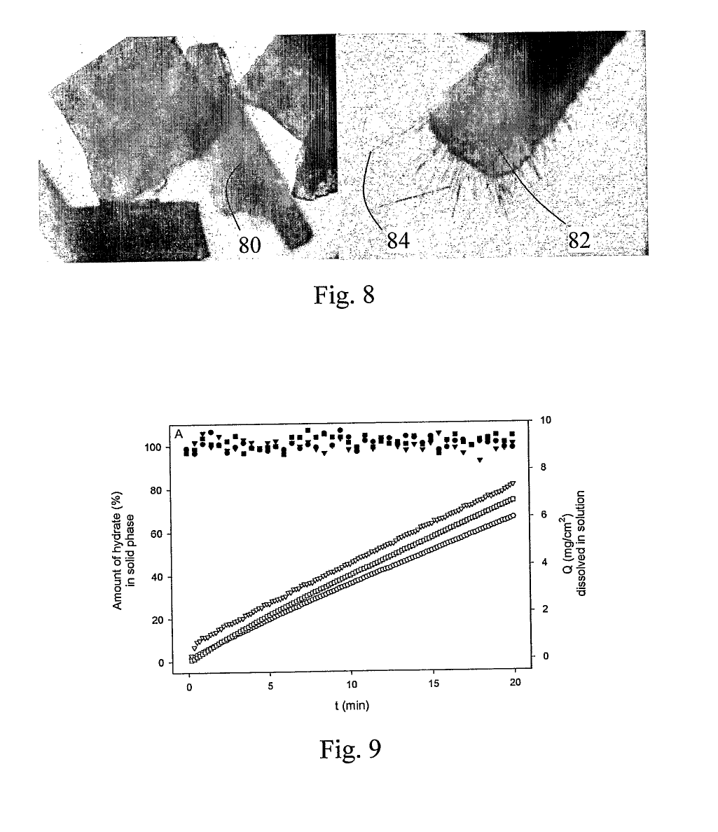

Some physical changes in the composition of the solid residue taking place on the surface of the residue can be detected also visually. According to one embodiment, optical means functioning in the visible wavelength range are utilized for the analysis of the composition of the residue. An optical microscope, preferably connected to digital data acquisition and/or analysis means, can be employed in this embodiment. An example of optical detection is shown in FIG. 8. In the figure, anhydrous sulfaguanidine slurry 80, 82 is shown in its initial condition (on the left) and after being immersed in water for 20 minutes (on the right). The analysis can be carried out solely by optical means or optically acquired images can be used for defining a region of interest for focusing other measurement means, for example, an spectroscopic probe. Referring to FIG. 8, the location of a growing crystal 84 can be detected using a microscope and a Raman probe can be focused on that specific crystal, provided that the sample is placed at a steady location. Alternatively, different polymorphs of a substance can in some cases be identified directly from visual images (new form having visually identifiable different habit, e.g., needle like crystals growing on the surface of plate like crystals). In such cases, solid residue analysis based solely on visual observation can be sufficient.

According to a preferred embodiment, analysis of the dissolution medium and of the solid residue are carried out using an analysis method, which is suited for both liquid and solid state analysis. That is, Raman spectrometry, for example, can be used for both purposes. A first Raman probe is used for in situ concentration measurement and a second Raman probe is focused on the solid residue for in situ composition analysis. Alternatively, the analysis of both the solution and the residue can be carried out by utilizing only one probe by spectral analysis. This analysis method provides synergy and financial benefits in manufacturing the hardware and software for improved dissolution experiments according to the present method.

According to a preferred embodiment, the apparatus comprises a cavity into which dissolution medium can be conducted and means for holding the sample in the cavity. According to one embodiment the dissolution medium is channeled to flow past the solid sample, which is placed in the cavity. Thus, the cavity acts as a flow-through chamber (flow-through cell). The apparatus can further comprise a liquid reservoir and the dissolution medium is arranged to circulate via conduits from the reservoir through the cavity and via the means for analyzing the solution back to the reservoir. According to another embodiment, the cavity is formed of a dissolution vessel into which dissolution medium is arranged. The sample is then immersed in the dissolution medium for initiating the dissolution process. Open or closed fluid circulation may be employed.

According to one embodiment, the solid sample is arranged in an essentially fixed position inside a flow-through chamber (cell), the dissolution medium is channeled to flow past the solid sample and a probe is arranged in the vicinity of the solid sample for analyzing the composition of the solid residue. Thus, the apparatus can comprise a liquid reservoir, the cavity having an inlet and outlet for the dissolution medium, and the apparatus comprising means for continuously circulating the dissolution medium via conduits from the liquid reservoir through the cavity and via the means for analyzing the solution back to the reservoir. The use of flow-through devices enables easy integration of many different measurement techniques. The flow-through chamber can be manufactured in many geometrical configurations and in variable scales, which enables placing the chamber in X-ray diffractogram or even in a NMR probe, for example. The analysis of the solution can be made outside the solid state analysis device.

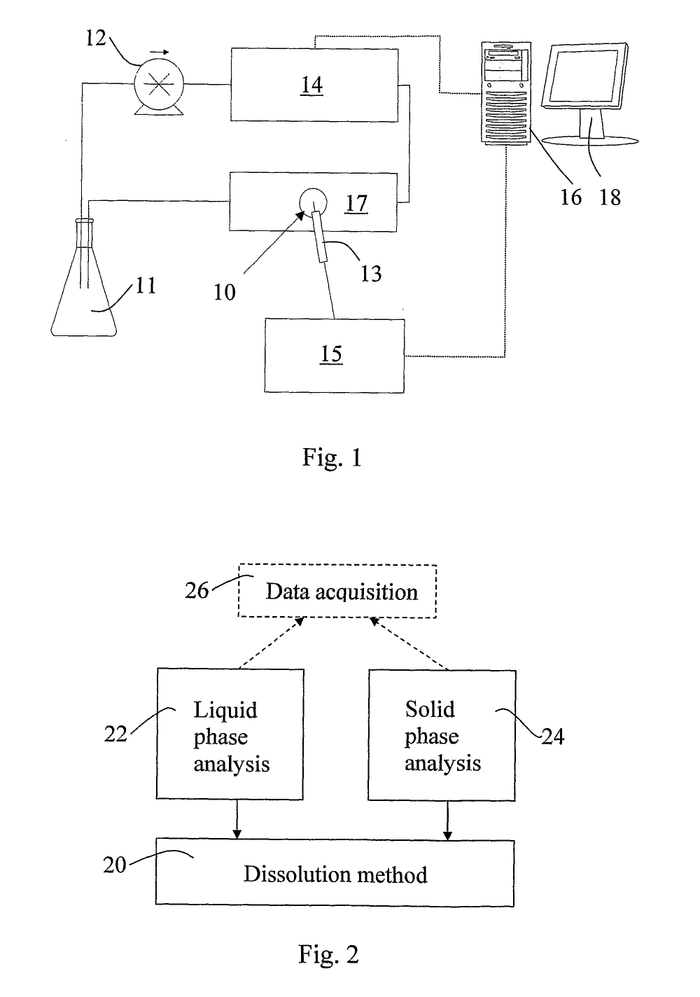

FIG. 1 illustrates one embodiment of the apparatus suitable for the present method. The apparatus represents a flow-through dissolution device, wherein the solid sample 10 is placed in a flow-through chamber 17. The dissolution medium is circulated from a container 11 via suitable conduits through the chamber 17 and a liquid phase spectrometer 14. As the dissolution medium passes the chamber 17, where the dissolution medium is arranged to contact the sample 10, the sample begins to dissolve. The spectrometer 14 adapted to carry out the analysis of the liquid phase of the system as the solution flows through the spectrometer. A pump 12 can be employed for achieving a circulation velocity suitable for the experiment. A probe 13 can be placed in the vicinity of the sample 10 for analysis of the solid residue. The probe 13 can, for example, be a fiber optic probe which is connected to a spectrometer 15.

Although FIG. 1 shows an embodiment utilizing closed circulation of the dissolution medium, the system may be realized as an open system as well.

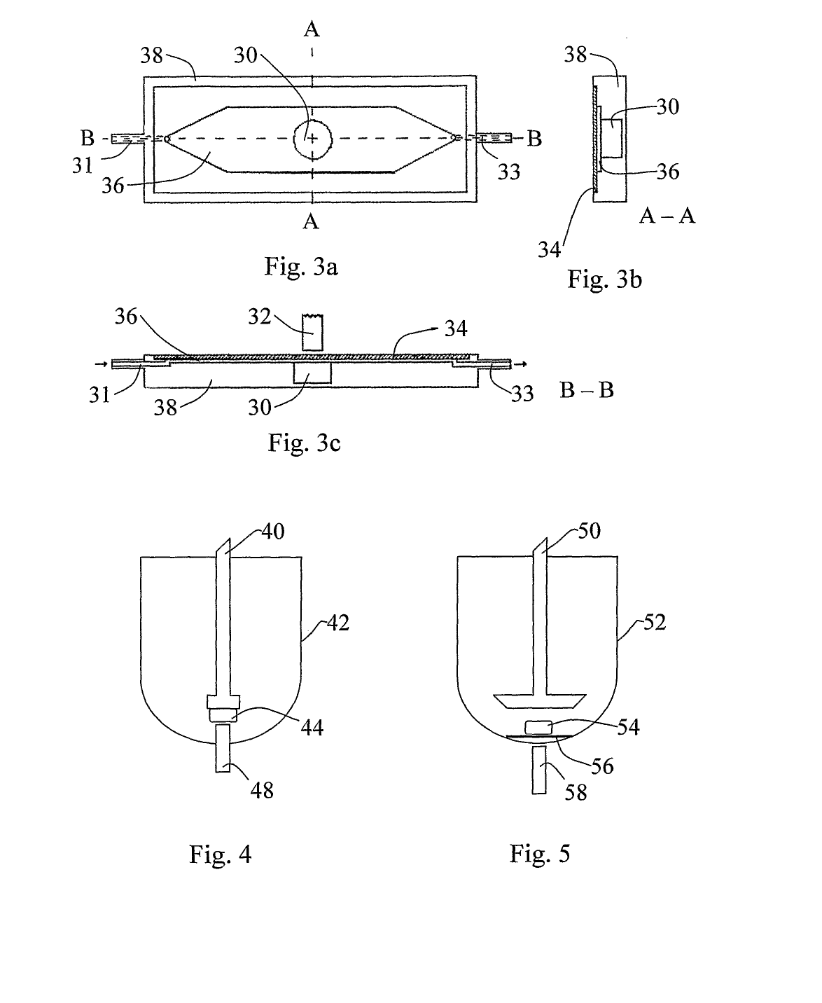

A detailed example of a chamber 17 is shown in FIGS. 3a to 3c. The chamber has walls 38, which can be fabricated, for example, of plastic, ceramic or glass material. The dissolution medium is fed into the chamber via an inlet 31 and conducted out via an outlet 33. Between the inlet 31 and the outlet 33, the chamber exhibits a flow-through section 36. The flow-through section 36 exhibits means for holding the sample, i.e., a sample hollow 30 for receiving the dosage form to be dissolved. At least on one side wall of the chamber, aligned with the sample hollow 30 there is an opening, which is covered with a window 34. The window 34 is preferably made of glass, or any other material, which is essentially permeable to the radiation used. A probe 32 can be placed in the vicinity of the window 34 facing the sample in the sample hollow 30. The hollow 30 can exhibit further means for holding the sample at a steady position. The outer dimensions of the device shown in FIGS. 3a to 3c are typically in centimeter-scale. The thickness of the liquid column between the probe 32 and the sample is preferably such, that the contribution from the liquid phase in the measured signal is low, preferably less than 20%, in particular less than 5%. The thickness of the flow-through section can be, for example, 0.5-3 mm.

The dissolution medium can be brought into laminar or turbulent motion in the vicinity of the sample. Turbulent motion can be achieved by increasing the velocity of the circulation or by arranging suitable guides in the vicinity of the sample in the flow-through section 36.

According to another embodiment, the dissolution medium is arranged in a dissolution vessel, the solid sample is immersed in the dissolution medium, the dissolution medium and the sample are brought into relative motion with each other and a probe is arranged in the vicinity of the sample for analyzing the composition of the solid residue. FIGS. 4-7 illustrate further examples of this embodiment.

Referring to FIG. 4, according to one embodiment, the dissolution medium is arranged in a dissolution vessel 42, the solid sample is mounted on a sample means 40 having essentially elongated shape, the solid sample 44 is immersed in the dissolution medium and the sample means is moved, for example, rotated or reciprocated, with respect to the dissolution vessel 42. At least part of the means 48 for analyzing the composition of the solid residue, e.g., a fiber optic probe, penetrates through the wall of the dissolution vessel and extends in the vicinity of the solid residue. Alternatively, the probing means 48 can be arranged inside the sample means, penetrating through the upper opening of the dissolution vessel, or outside the vessel directed to the solid residue. In this embodiment, in addition to fiber optic detection, also X-ray or visual detection means can be employed.

FIG. 5 shows an alternative embodiment, in which the dissolution medium is arranged in a dissolution vessel 52, the solid sample 54 is mounted on a steady location inside the vessel 52 immersed in the dissolution medium and the dissolution medium is stirred with stirring means 50, such as a paddle, for bringing the liquid in relative movement with the sample. At least part of the means 58 for analyzing the composition of the solid residue, e.g., a fiber optic probe, can be arranged inside the stirring means, penetrating through the wall or opening of the dissolution vessel, or outside the vessel directed to the solid residue. Sample mounting means 56, such as a disc, can be provided (as in USP V apparatus) for holding the solid residue steady during the test. When the probe is placed below the residue as shown in FIG. 5, the disc 56 and the dissolution vessel are preferably made of glass or polymer permeable to the type of radiation used. In this embodiment, in addition to fiber optic detection, also X-ray or visual detection means can be employed.

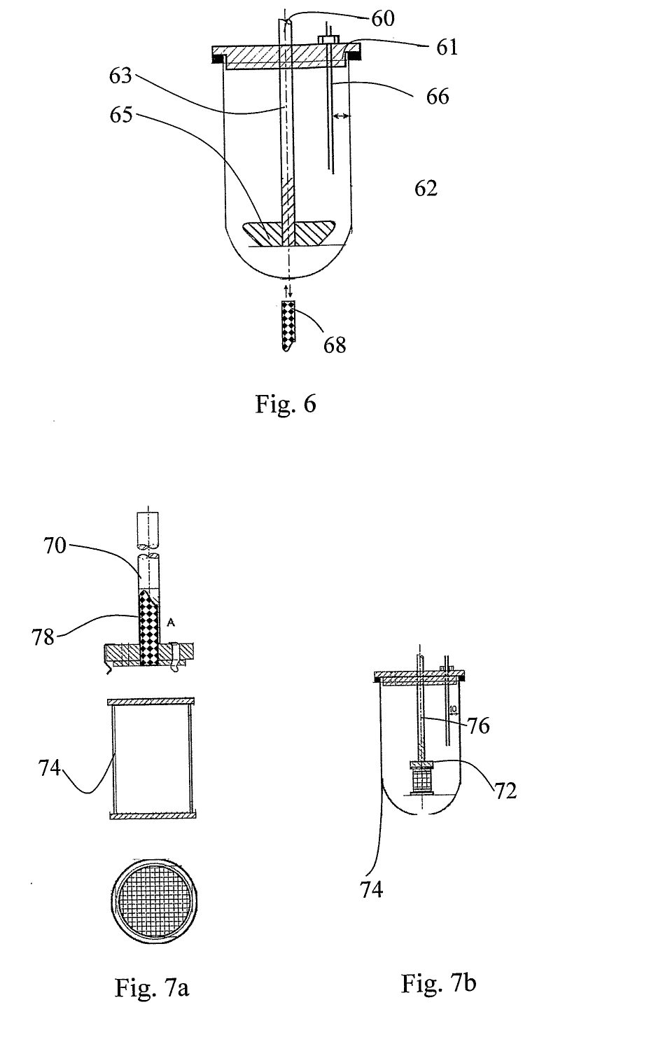

FIG. 6 depicts a detailed view of an apparatus according to Ph. Eur.-type dissolution paddle apparatus standard. The figure is based on a figure from European Pharmacopoeia. A rotating element 60 formed of a shaft 63 and a blade 65 is arranged through a covering 61 of a dissolution vessel 62. A pipe or capillary 66 is also arranged through the covering 61 for conducting samples of solution to solution analysis means. A probe 68 for non-contact measurement from outside of the paddle apparatus is provided outside the vessel 62. Instead of placing the probe as shown in FIG. 6, the probe can also be placed inside the shaft 63, as will be apparent from FIG. 7a. Generally, if a dissolution arrangement employing a rotating or reciprocating shaft is used, the probe for measuring the solid residue can be placed inside the shaft, optionally together with the in situ probe for measuring the liquid phase.

FIGS. 7a and 7b show detailed cross-sectional views of an apparatus according to Ph. Eur.-type dissolution basket apparatus. The figure is based on a figure from European Pharmacopoeia. A basket 74 mounted on a shaft 70 is provided inside a dissolution vessel 72. The sample is placed inside the basket 74. In this embodiment, a fiber-optic probe 78 is preferably placed inside the shaft 70 such that the head of the probe extends in the vicinity of the basket.

The sample and at least the probing part of the means for analyzing the composition of the solid residue are preferably arranged in an essentially fixed position with respect to each other.

Referring back to FIG. 1, according to one embodiment, the means for analyzing the solution and the means for analyzing the composition of the solid residue, such as spectrometers 14 and 15, are connected to data acquisition means 16 which can, for example, comprise a computer. The data acquisition means 16 can be adapted to retrieve data on analyses from analyzing means in real-time, at suitable intervals or after the experiment has ended. Thus, the spectrometers 14 and 15, for example, can be provided with working memory for storing the measurement data. The data acquisition means 16 can also be provided with data analysis and/or illustration (display) means 18 for enabling monitoring of the dissolution testing results in real-time and/or after the experiment. By this means, the interrelation between the solid and liquid state properties of the system can be detected most readily and conveniently. As appreciated by a person skilled in the art, in addition to the flow-through embodiment shown in FIG. 1, the data acquisition means can correspondingly be utilized also in vessel-type dissolution equipment.

According to one embodiment the dissolution apparatus comprises also experiment control means for controlling the parameters of the dissolution experiment. The data acquisition means 16 can also be connected to control means for controlling the parameters in response to acquired data during the testing. The data acquisition means 16 and control means can also comprise only one unit, for example, a computer. The controllable parameters include, for example, temperature of the liquid phase of the system and circulation velocity of the solution. The system allows also addition of new substances into the circulation during the experiment, which enables, for example, studying of combined effects of multiple drugs taken one after another. It may be, for example, that the dissolution rate of a first tablet is decreased due to dissolving of another drug, whose ingredients can crystallize onto the first tablet thus inhibiting the release of the active agent. By controlling the temperature of the solution, the dependency of the changes in the solid phase and in the dissolution rate on the temperature can be studied.

The following examples illustrates the capabilities of the present method referring to FIGS. 9-12, which represent true measurement data.

### Example 1

This example describes a set of experiments carried out with one model substance. An apparatus of the kind illustrated in FIG. 1 and described above was used in these experiments.

The improved dissolution method disclosed in this document was tested experimentally for different tablet formulations:

A theophylline monohydrate,
B theophylline anhydrate, and
C microcrystalline cellulose:theophylline anhydrate, 1:1 weight.

The results are shown in FIGS. 9-11, respectively. The concentration of active agent in the liquid phase and the amount of hydrate in the solid phase was measured. Open symbols refer to concentration in solution, and closed symbols refer to amount of hydrate in solid tablets, different symbols refer to replicate experiments.

Theophylline (TP) monohydrate was prepared by recrystallization of theophylline (Orion Pharma, Espoo, Finland) from distilled water. Theophylline monohydrate crystals were stored at room temperature and 75% RH. Theophylline anhydrate was obtained by dehydration of theophylline monohydrate at 100 ° C., under reduced pressure (72 mbar), for 24 hours. Theophylline anhydrate crystals were stored at room temperature and 0% RH. The polymorphic forms were verified by XRPD. Microcrystalline cellulose (MCC, Emcocel 50, Penwest Pharmaceuticals, Nastola, Finland) was used as an excipient.

Tablet formulations A, B and C were mixed in a turbula mixer (Turbula T2C, Willy A. Bachofen Maschinenfabrik, Basel, Switzerland) for 5 minutes and compressed using a single punch tablet machine (Korsch EK0, Erweka Apparatebau, Germany) using flat-faced punches (punch diameter=9 mm) (Table 1). The target weight of the tablets was 150 mg. The tablets were compressed to a crushing strength of 70 N.

TABLE 1
Tablet formulations (w/w percentages).

| | A | B | C |
|---|---|---|---|
| TP monohydrate | 100% | | |
| TP anhydrate | | 100% | 50% |
| MCC | | | 50% |

Dissolution testing was carried out employing simultaneous liquid/solid phase analysis. A modified flow-through dissolution method was used, in which
the concentration of the medium was measured with a UV-Vis spectrophotometer and
a simultaneous solid state analysis on the dissolving tablet in a flow-through chamber was performed using an in situ Raman spectroscopic analysis.

The dissolution testing setup consisted of the flow-through cell, liquid reservoir (V=500 ml) and a peristaltic pump that circulates the medium (pump speed=70 rpm 9,3 ml/min). The dissolution medium used in the experiments was distilled water (room temperature).

The concentration of the dissolution medium was determined with an in-line UV-Vis spectrophotometer (Ultrospec III, Pharmacia LKB Biotechnology, Uppsala, Sweden) at 272 nm using a flow-through cuvette.

The Raman spectra were collected using a Raman spectrometer (Control Development, South Bend, Ind., USA) with a diode laser (Starbright 785 S, Torsana Laser Technologies, Skodsborg, Denmark) at 785 nm. A fiber optic sampling probe (InPhotonics, Norwood, MA, USA) was used. The spectral range measured was 2200-100 cm⁻¹ at a resolution of 5 cm⁻¹.

In the case where tablet under investigation consisted of TP monohydrate (Table 1, formulation A) the dissolution media induced no solid state conversions—The polymorphic form of the drug remained unchanged from start to finish. Therefore no changes in the dissolution rate were noticed either (FIG. 9).

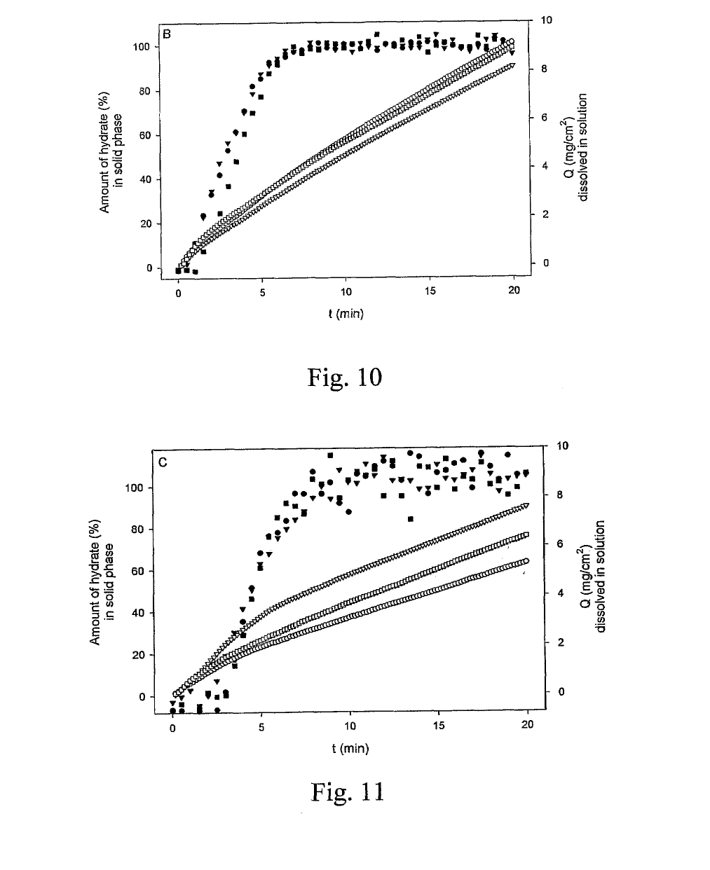

When the tablet comprised of TP anhydrate (formulation B) or TP anhydrate—MCC mixture (formulation C) the changes in the performance of the drug were obvious: TP anhydrate undergoes a solvent mediated phase transition to TP monohydrate (FIGS. 10 and 11). Due to the change in the solid state properties a clear decrease in the dissolution rate was detected.

In case C the possible effects of excipient (MCC) in the tablet formulation were studied. MCC did not disable analysis of either the liquid or the solid state. A delay in polymorphic conversion and dissolution rate change was noticed (FIG. 11).

### Example 2

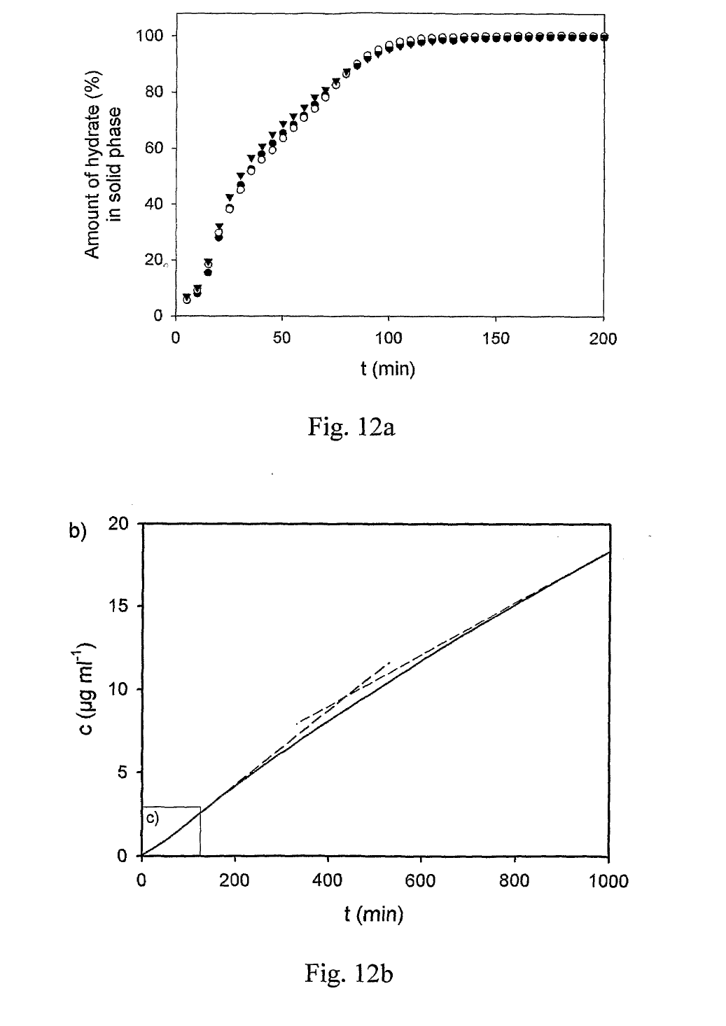

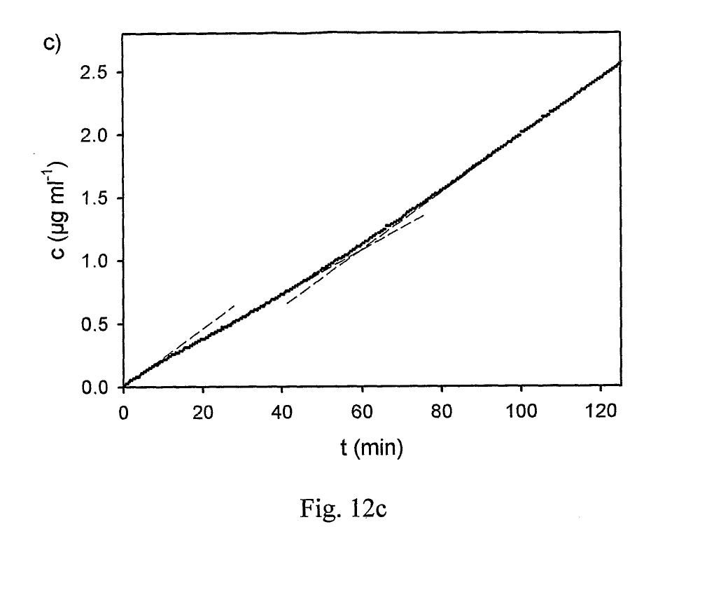

Dissolution of Nitrofurantoin (NF) anhydrate (form β) was measured with the same setup as TP (Example 1). In the dissolution tests performed with NF the flow rate of the dissolution medium was set to 20 ml/min. FIG. 12a shows the solid phase transformation of NF anhydrate to NF monohydrate (II). FIGS. 12b and 12c show the concentration of the dissolution medium. The solid-state transformation of NF anhydrate was an order of magnitude slower than that of TP anhydrate. The changes of the dissolution rate were more complicated when compared to changes in the dissolution rate of TP.

What is Claimed is:

1. A method for monitoring properties of a solid sample during a dissolution process, the sample comprising at least one soluble component, and the method comprising:
bringing the solid sample into contact with dissolution medium for producing a solution and a solid residue of the solid sample, and the combination of
analyzing the solution for determining the concentration of the soluble component during the dissolution process, and
simultaneously analyzing the atom- or molecule-scale physical or chemical composition of the solid residue.

2. The method according to claim 1, wherein the step of analyzing the composition of the solid residue comprises monitoring the crystal structure of the residue.

3. The method according to claim 1, wherein the step of analyzing the composition of the solid residue comprises monitoring the polymorphous state of at least one component of the sample.

4. The method according to claim 1, wherein the step of analyzing the composition of the solid residue comprises monitoring the amount of at least one component in the solid residue.

5. The method according to claim 3, wherein said component is other than the soluble component.

6. The method according to claim 4, wherein said component is selected from the group of: hydrates of the component and solvates of the component.

7. The method according to claim 1, wherein the step of analyzing the composition of the solid residue comprises analyzing the chemistry of the solid residue.

8. The method according to claim 1, wherein the step of analyzing the composition of the solid residue is carried out by spectroscopic means, such as by UV, UV-Vis, IR,, Raman or X-ray spectroscopy.

9. The method according to claim 1, wherein using a fiber optic probe arranged in the vicinity of the solid sample and connected to a spectroscopic unit for analyzing the composition of the solid residue.

10. The method according to claim 1, wherein the step of analyzing the composition of the solid residue comprises utilizing visual observation of the composition solid residue.

11. The method according to claim 10, wherein visual observation is further used for focusing a Raman, IR, UV, or X-ray probe onto a specific area of the solid residue.

12. The method according to claim 1, wherein the solid sample is arranged in an essentially fixed position inside a flow-through chamber, the step of bringing the solid sample into contact with dissolution medium comprises conducting the dissolution medium past the solid sample, and a probe is arranged in the vicinity of the solid sample for analyzing the composition of the solid residue.

13. The method according to claim 1, wherein the dissolution medium is arranged in a dissolution vessel, the solid sample is immersed in the dissolution medium, the dissolution medium and the sample are brought into relative motion with each other and a probe is arranged in the vicinity of the sample for analyzing the composition of the solid residue.

14. The method according to claim 1, wherein dissolution medium is channeled to means for analyzing the solution for determining the concentration of the soluble component.

15. The method according to claim 1, wherein analysis of the solution for determining the concentration of the soluble component is carried out in situ.

16. The method according to claim 1, wherein data on the analysis of the solution and on the composition of the solid residue are transferred to data acquisition means for further analysis of the dissolution process.

17. An apparatus for monitoring dissolution properties of a solid sample, which comprises at least one soluble component, the apparatus comprising
a cavity into which dissolution medium can be conducted, and
means for holding the sample in the cavity in contact with the dissolution medium for producing a solution and a solid residue of the sample, wherein the apparatus comprises in combination
means for analyzing the solution for determining the concentration of the soluble component, and
means for simultaneously analyzing the atom- or molecule-scale physical or chemical composition of the solid residue.

18. The apparatus according to claim 17, wherein the means for analyzing the composition of the solid residue comprises a spectroscopic unit, such as a Raman spectrometer, UV, UV-vis, or IR, spectrometer or an X-ray spectrometer.

19. The apparatus according to claim 17, wherein the means for analyzing the composition of the solid residue comprise a probe, which is arranged in the vicinity of the solid sample and connected to a spectroscopic unit.

20. The apparatus according to claim 19, wherein the probe is a fiber optic probe mounted to the means for holding the sample in the cavity.

21. The apparatus according to claim 19, wherein the probe is placed outside the walls of the cavity and directed to the solid residue in the cavity.

22. The apparatus according to claim 17, wherein the means for analyzing the composition of the solid residue comprise an X-ray spectroscopic unit, the cavity is provided with at least one X-ray permeable window, and the sample is arranged in the vicinity of the window for probing the solid residue through the window.

23. The apparatus according to claim 17, wherein the sample and at least part of the means for analyzing the composition of the solid residue are arranged in an essentially fixed position with respect to each other.

24. The apparatus according to claim 17, wherein the apparatus further comprises a liquid reservoir, the cavity has an inlet and outlet for the dissolution medium, and the apparatus comprises means for continuously circulating the dissolution medium via conduits from the liquid reservoir through the cavity and via the means for analyzing the solution back to the reservoir.

25. The apparatus according to claim 17, wherein the apparatus further comprises data acquisition means for retrieving analysis data from the means for analyzing the solution and from the means for analyzing the composition of the solid residue.
